(19) United States
(12) Patent Application Publication
(10) Pub. No.: US 2011/0139005 A1
(43) Pub. Date: Jun. 16, 2011

(54) Air Purifier Employing A Water Jet-Type Fan System, and Purification Method Thereof

(76) Inventor: Yong Joon Kwon, Seoul (KR)

(21) Appl. No.: 13/060,250

(22) PCT Filed: Feb. 18, 2010
(86) PCT No.: PCT/KR10/01016

§ 371 Date: Feb. 22, 2011

(30) Foreign Application Priority Data
Feb. 23, 2009 (KR) 10-2009-0014705

(51) Int. Cl. B01D 47/06

(52) U.S. Cl. 95/216; 261/25; 95/224

(57) ABSTRACT

The present invention relates to an air purifier employing a water jet-type fan system having a simple structure, in which water is pumped by a water pump and sprayed and scattered by the water jet-type fan system in which a plurality of spray nozzles are mounted on a fan having a flow channel, in order to purify contaminants. The fan system rotates by the principle of action and reaction using the spraying force of water. The air purifier of the present invention performs an air purification process and an air circulation function at the same time by spraying and scattering water so as to use the adsorption power of water, instead of using a motor fan for circulating air. The present invention also relates to a purification method of the air purifier.

### TECHNICAL FIELD

The present invention relate to a water jet type air purifier that purifies air using the adsorption power of water, and more particularly to, an air purifier employing a water jet-type fan device having a simple structure, in which water is pumped by a water pump and the pumped water is sprayed and scattered by the water jet-type fan device including a plurality of spray nozzles mounted on fan blades having flow channels formed thereon in order to purify contaminants. The fan device rotates by the principle of action and reaction using the water spraying force. The air purifier of the present invention performs an air purification process and an air circulation function at the same time by spraying and scattering water to use the adsorption power of water, instead of using a separate motor fan for circulating air. The present invention also relates to a purification method of the air purifier.

### BACKGROUND ART

In general, air purifiers are installed in homes, offices, or the like to remove foreign substances, harmful gases, or the like contained in the air by forcibly circulating indoor air, and then again discharge the air from which the foreign substances, harmful gases, or the like is removed to the indoor, thereby keeping an indoor air environment in a pleasant state.

The air purifiers are broadly classified into the following three types: a type in which a variety of contaminants in the air are filtered by a filter, a type in which the contaminants are adsorbed by and sedimented in water, and a type in which the contaminants are charged electrically at a high voltage to collect dust. The simple application or various combinations of such air purification methods enable purification of air.

The circulation of air purified by the air purifier is generally performed in such a fashion that a fan is operated by driving an electric motor to suck in and purify contaminated air, the purified air is discharged, and contaminated air is sucked in to thereby circulate indoor air.

A majority of the fans entail a problem in that since they are operated by a separate motor, air purification efficiency is degraded due to an operation noise or foreign substances, or the like adhered to the fan motor and fan blade surfaces as well as a user suffers from an inconvenience of having to frequently clean the fans.

In addition, since a wet-type air purifier that purifies air with the adsorption power of water through the direct use of water requires a separate facility such as a water spraying and scattering device, and the like, it is complicated structurally and increases in size, which leads to an increase in the manufacturing cost and makes its maintenance and repair difficult. Besides, the use of water is problematic in safe use of electricity such as an electric leakage of the fan motor.

### DISCLOSURE OF INVENTION

### Technical Problem

Accordingly, the present invention has been made in order to solve the above-mentioned problems associated with the prior art, and it is an object of the present invention to provide an air purifier having a simple structure in which a water jet-type fan device including a plurality of spray nozzles is rotated by the principle of action and reaction using the water spraying force generated in the pumping process of a water pump so as to perform a process of spraying and scattering water as well as an air circulation function of sucking in and purifying contaminated air, and then discharging the purified air on a combination basis, thereby eliminating the necessity of a complicated facility such as a separate motor fan for circulating air, a water spraying and scattering device, and the like, and fundamentally solving problems of a motor fan noise and an electric leakage of the fan, etc.

Another object of the present invention is to provide a low-cost and high-efficiency air purifier in which since fan blades are rotated while coming into close contact with water being sprayed and dropping down, they are always maintained in a clean state, thereby avoiding the risk of degrading an air purification efficiency due to foreign substances or the like stuck to fan blade surfaces, promoting the convenience of maintenance and repair owing to simplification of its structure, and ensuring stability in use.

### Technical Solution

To achieve the above objects, in one aspect, the present invention provides a low-cost and high-efficiency wet-type air purifier that purifies air using the adsorption power of water, the air purifier including: a lower water tank 300 configured to store a certain amount of water therein, an intermediate water tank 200 disposed within the lower water tank, the intermediate water tank including an air outlet 212 formed at an upper portion thereof and an air circulation flow channel 214 formed at a lower portion thereof to fluidically communicate with the lower water tank; an air purification chamber main body 100 mounted at an upper portion of the intermediate water tank, the main body including a separation type cover at an upper end thereof and internally defining a space for purifying contaminated air, the cover having an air inlet formed thereon; a water jet type fan device 204 disposed at the inside of the air purification chamber and including a plurality of water spray nozzles mounted on a plurality of fan blades each having a flow channel formed thereon and a seal bearing mounted in a body of the fan device; a water supply pipe connected to the water jet type fan device and a water pump 215 connected to the water supply pipe to pump water up; a controller configured to control the water pump and a water flow control valve 210 of the water supply pipe; and a conical sloping plate 213 installed in the intermediate water tank so as to prevent the noise of water falling from the top, wherein water contained in the lower water tank 300 is pumped by the water pump and the pumped water is sprayed and scattered by the water jet-type fan device 204 including a plurality of spray nozzles 201 and 205 mounted on the body and fan blades of the fan device having flow channels 207 formed thereon in order to purify contaminants, and wherein the fan device is rotated by the principle of action and reaction using the water spraying force as a rotation driving power, so that the air purifier performs a water spraying and scattering process and an air circulation function at the same time on a combination basis by adopting the water jet-type fan device 204 instead of a separate motor fan for circulating air, whereby eliminating the necessity of a complicated facility such as a separate motor fan for circulating air, a water spraying and scattering device, and the like, and promoting convenience of maintenance and repair of a user and ensuring safety in use.

In addition, water sprayed through the water jet type fan device in the air purification chamber 100-1 is scattered after impinging against the inner wall surface of the air purification chamber main body and some water flowing down along the inner wall surface of the air purification chamber main body re-impinges against the conical scattering protrusions formed on the top surfaces of the rotating fan blades to form finer water droplets to increase the contact surface area with polluted air to improve an air purification capability.

Moreover, wherein the water jet type fan device 204 of the air purifier is provided with a double-stage structure to increase the contact surface area with polluted air to further improve the air purification capability.

### Advantageous Effects

The present invention as constructed above has the following operational effects.

First, the wet-type air purifier that purifies air using the adsorption power of water of the present invention has an effect in that water is sprayed and scattered by using the water jet-type fan device 204 including the plurality of spray nozzles mounted on fan blades of the fan device having flow channels formed thereon instead of a separate motor fan for circulating air so that the air purifier performs a water spraying and scattering function as well as an air circulation function according to the rotation of the fan device at the same time on a combination basis by adopting the water jet-type fan device 204 instead of a separate motor fan for circulating air, thereby eliminating the necessity of a complicated facility such as a separate motor fan for circulating air, a water spraying and scattering device, and the like to reduce the manufacturing cost of the air purifier and fundamentally solve problems of a motor fan noise.

Second, the present invention has another effect in that a combined function of both air purification and natural humidification can be performed, as if the sky became clear after rains, by the air purifier having a simple structure which uses water as a gifted natural filter source and adopts the water jet type fan device, thereby promoting the convenience of maintenance and repair.

Third, the present invention has yet another effect in that when the air purification chamber main body 100 is made of a transparent material, an equivalent interior design effect to that in which an outdoor fountain is installed indoor, can be obtained additionally.

### BRIEF DESCRIPTION OF THE DRAWINGS

FIG. 1 is a longitudinal cross-sectional view illustrating a wet-type air purifier in operation according to the present invention.

FIG. 2 is an exploded perspective view illustrating the construction of a water jet type fan device of the present invention.

FIG. 3 is a perspective view illustrating an operation state in which water is sprayed by a water jet type fan device and a rotating spray member mounted at an upper end thereof according to the present invention.

FIG. 4 is a perspective view illustrating an arrangement state in which spray nozzles of both a water jet type fan device and a solid spray member mounted at an upper end thereof are arranged according to the present invention.

FIG. 5 is a perspective view illustrating a state in which spray nozzles are all mounted at a fan device body in a water jet type fan device according to the present invention.

FIG. 6 is a perspective view illustrating a state in which spray nozzles are all mounted at a fan device body and fan blades can be separated from the fan device body in a water jet type fan device according to the present invention.

FIG. 7 is a perspective view illustrating an operation state in which only a fan with a built-in seal bearing is rotated in a water jet type fan device according to the present invention.

FIG. 8 is a cross-sectional view illustrating a state in which a water jet type fan device is provided with a double-stage structure according to the present invention.

FIG. 9 is a perspective view illustrating an air purification chamber main body having flow channels formed at a lower portion thereof to allow for flow of water and air according to the present invention.

FIG. 10 is a perspective view illustrating an air purification chamber main body having flow channels formed at a lower end portion thereof to allow for flow of water and air according to the present invention.

FIG. 11 is a perspective view illustrating a modified intermediate water tank having a chair-type structure that fixedly supports an air purification chamber main body according to the present invention.

### BEST MODE FOR CARRYING OUT THE INVENTION

Now, preferred embodiments of a wet-type air purifier employing the adsorption power of water and a purification method thereof according to the present invention will be described hereinafter in detail with reference to the accompanying drawings.

An air purifier 10 of the present invention includes: a lower water tank 300 that stores a certain amount of water therein, an intermediate water tank 200 that is disposed within the lower water tank and that includes an air outlet 212 formed at an upper portion thereof and an air circulation flow channel 214 formed at a lower portion thereof to fluidically communicate with the lower water tank; an air purification chamber main body 100 that is mounted at an upper portion of the intermediate water tank and that includes a separation type cover at an upper end thereof and internally defines a space for purifying contaminated air, the cover having an air inlet formed thereon; a water jet type fan device 204 that is disposed at the inside of the air purification chamber and includes a plurality of water spray nozzles mounted on a plurality of fan blades each having a flow channel formed thereon and a seal bearing mounted in a body of the fan device; a water supply pipe 209 that is connected to the water jet type fan device and a water pump 215 that is connected to the water supply pipe and pumps water up; a controller that controls the water pump and a water flow control valve 210 of the water supply pipe; and a conical sloping plate 213 that is installed in the intermediate water tank so as to prevent the noise of water falling from the top.

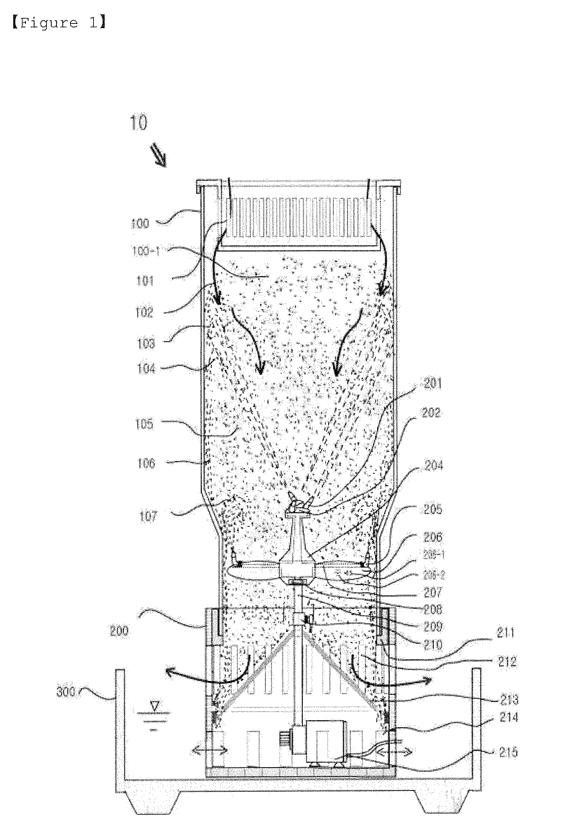

As shown in FIG. 1, there is shown an example of a two-stage spray nozzle adopted by the water jet type fan device. Water is filled in the intermediate water tank 200 in which the water pump 215 and the conical sloping plate 213 are set in a state in which the intermediate water tank 200 is placed in the lower water tank 300 capable of storing a certain amount of water. Then, the water is pumped up by the water pump 215 and is sprayed upwardly at an angle of about 20° by the spray nozzles 205 mounted on the fan blades and at an angle 45° by the spray nozzles 201 through the water jet type fan device 204. Thereafter, the upwardly sprayed water is scattered after impinging against the inner wall surface of the air purification chamber main body 100. At this time, some water 106 flowing down along the inner wall surface of the air purification chamber main body without being scattered is re-scattered after impinging against the water sprayed upwardly at the angle of about 20° to form water droplets 107. In the above two steps, the scattered and falling water droplets re-impinge against a plurality of conical scattering protrusions 206-1 formed on the top surfaces of the rotating fan blades 206 to form finer water droplets to improve an air purification capability. The spraying angle of the spray nozzles 205 mounted on the fan blades is set to the angle of about 20° in consideration of security of the proper number of revolutions of the fan and the water scattering effect due to the impingement of water 106 flowing down from the upper side against the fan blades as a result of a simple experiment. The spraying angle of the spray nozzles 205 may slightly vary depending on the capacity of the water pump and the size of the fan blades.

The lower water tank 300 includes a drain device needed for draining polluted water and replenishing clean water besides a simple function of storing a certain amount of water. The air purifier is typically installed in homes or small-sized offices. In addition, the air purifier is configured of a top-open type which is separated from the intermediate water tank 200 to easily confirm the level of water or a degree of pollution of water. In addition, the air purifier facilitates replenishment or exchange of water, and thus can exclude the drain device or a water level indicator.

Disposed in the intermediate water tank 200 is the water pump 215. The intermediate water tank 200 includes an air outlet 212 formed at an upper portion thereof and an air circulation flow channel 214 formed at a lower portion thereof to fluidically communicate with the lower water tank. In addition, the intermediate water tank 200 is constructed to have a supporting step 211 that allows the air purification chamber main body 100 to be fixedly mounted on the intermediate water tank. A conical sloping plate is installed in the intermediate water tank 200 to prevent the noise of water falling from the top.

In addition, the intermediate water tank 200 is constructed such that it is can be separated from the lower water tank 300 and the air purification chamber main body 100 so as to facilitate its cleaning work or the replacement of polluted water of the lower water tank 300 with pure water.

Disposed in the air purification chamber main body 100 is the water jet type fan device 204. The air purification chamber main body 100 internally defines a space for purifying contaminated air and includes a separation type cover having an air inlet 101 formed at an upper end thereof.

Further, the air purification chamber main body 100 may be configured to be somewhat large to secure a sufficient water spraying space, i.e., a sufficient air purification space as shown in FIG. 1.

Mounted on the water supply pipe 209 interconnecting the water pump 215 and the water jet type fan device 204 is a water flow control valve (i.e., electronic valve) 210 to properly control the amount, height, and shape of water sprayed.

A controller (not shown) of the air purifier according to the present invention serves to control the adjustment of the amount of water pumped and the shape of water sprayed by the electronic valve 210. In addition, the controller may be additionally provided with a timer function for automatic turning ON/OFF of the air purifier.

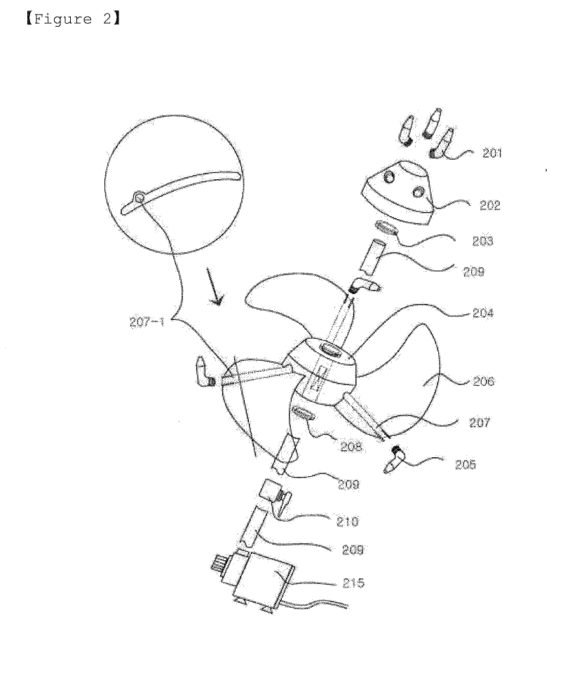

As shown in FIG. 2, the water jet type fan device 204 is constructed such that it includes a plurality of spray nozzles mounted on the fan blades formed with the flow channels and a spray member 202 is mounted on the fan device 204, the fan device 204 and the spray member 202 having seal bearing 203 and 208 being built therein, respectively, so as to be rotated. Water flowing through the water supply pipe 209 vertically extending from the water pump 215 and the water flow control valve 210 mounted on the water supply pipe 209 is supplied to the spray nozzles 205 via the flow channels formed in the fan blades and a body of the fan device and flows in an independently swirling fashion while being dispersed into a spray of water drops through the nozzles in the direction of the reaction to the action according to the water spraying angle of the nozzles.

In addition, the flow channels 207 formed in the fan blades of the water jet type fan device are positioned at lower sides of the top surfaces of the fan blades in the rotation direction of the fan blades, such that each flow channel is formed as shown in an enlarged cross-sectional view 207-1 to allow the fan blades to be rotated in a counter-clockwise direction. Thus, the resistance of air against a spray of water drops can be reduced, and a straight protruded portion formed on the top surface of the fan blade, which corresponds to the flow channel, functions to scatter the water sprayed from the spray nozzles.

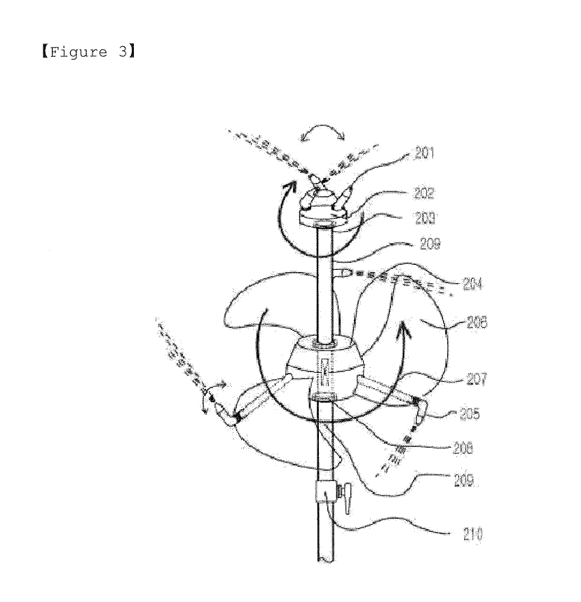

As shown in FIG. 3, a seal bearing is embedded in a body of the fan device formed with the flow channels in such a fashion as to be connected to the water supply pipe 209 vertically extending from the water pump. Thus, the fan device is rotated independently of the water supply pipe, and the respective spray nozzles 205 mounted on the fan blade flow channels 207 through the body of fan device and the respective upper spray nozzles 102 of the spray member 202 can be freely controlled in the water spraying angle. The water jet type fan device is rotated by the principle of action and reaction using a water spraying force generated by the water pump 215 as a rotation driving power. The spraying angle of each nozzle can be controlled to control the proper number of revolutions of the fan.

In other words, when the spraying angle of the spray nozzles 205 is set to be close to 0° relative to a horizontal axis of the fan device, an energy loss of the reaction to the action of the spray nozzles is reduced to increase the rotation speed of the water jet type fan device. On the contrary, when the spraying angle of the spray nozzles 205 is set to be closer to 90° relative to the horizontal axis of the fan device, water is sprayed higher upwardly through the spray nozzles, which leads to an increase in the air purification space, but an increase in an energy loss to somewhat decrease the rotation sped of the fan device.

Moreover, the rotation direction of the spray member varies depending on the water spraying direction of the respective spray nozzles. The spray nozzles 201 of the spray member 202 spray water in a counter-clockwise direction while being rotated in a clockwise direction in the reaction to the water spraying action as indicated by an arrow in FIG. 3. The spray nozzles 205 of the water jet type fan device spray water in a clockwise direction while being rotated in a counter-clockwise direction in the reaction to the water spraying action so as to circulate air.

Therefore, the spraying angle of each nozzle mounted on the water jet type fan device for air purification can be controlled to control the rotation speed and water spraying range of the fan device such that a degree of air purification and air circulation can be properly controlled. As shown in FIG. 3, the rotation direction of the spray member is set opposite to that of the water jet type fan device to create a vortex phenomenon in the air passing through the inside of the air purification chamber main body, so that it can be expected to further improve an air purification capability.

FIG. 4 shows the case in which the spray member 202 is configured of a solid type unlike the case of FIG. 3 in which the spray member 202 mounted at an upper end of the water jet type fan device is configured of a rotating type to spray water while being rotated.

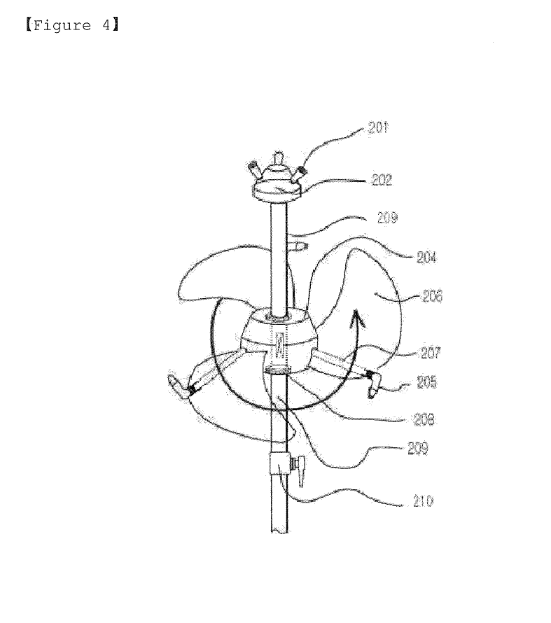

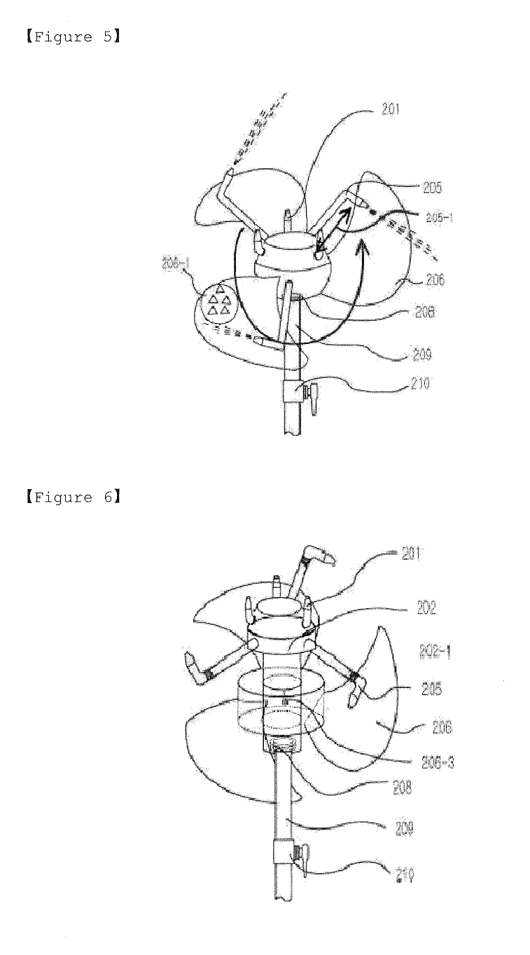

FIG. 5 shows a state in which all the spray nozzles 201 and 205 are integrally mounted at a body of the water jet type fan device.

In particular, the spray nozzles 205 are installed on the body between the adjacent fan blades instead of being installed on the fan blades so as to be oriented upwardly at an angle of about 20°. As indicated by an arrow 205-1 in FIG. 5, the length of the spray nozzle can be selected, and a number of conical scattering protrusions 206-1 formed on the top surface of the fan blade serve to disperse falling water droplets in a swirling fashion.

In FIG. 6, all the spray nozzles are mounted at the fan device body and fan blades are configured of a separation type, but not an integral type in addition to including the same function as that in FIG. 5. When a defect occurs in the fan blade, they can be easily replaced with new one.

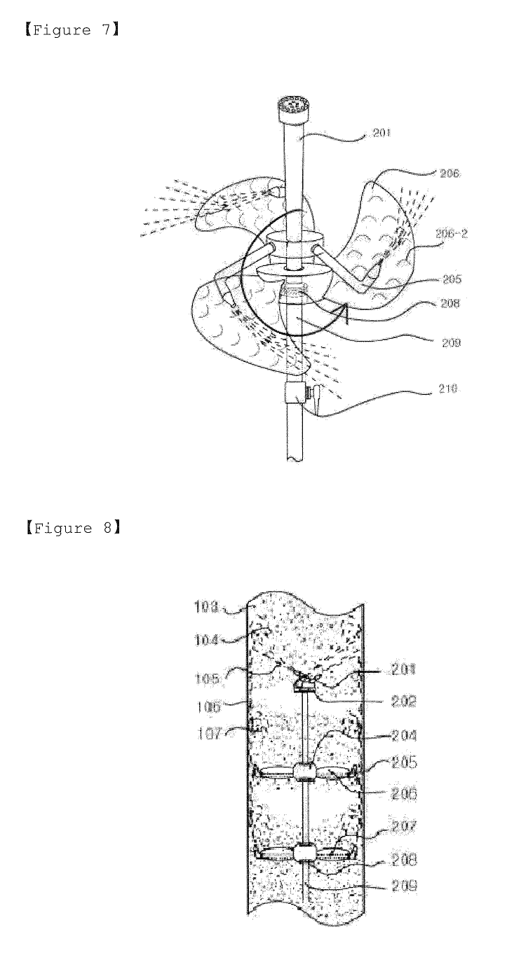

FIG. 7 shows an operation state of the water jet type fan device having a simple structure in which a seal bearing is built in the fan device body and water is directly sprayed onto a number of hemispherical protrusions 206-2 formed on the top surfaces of the fan blades through the spray nozzles of the solid spray member to rotate the fan blades.

FIG. 8 shows an example of a state in which the water jet type fan device is provided with a double-stage structure to further improve the air purification capability.

### Modified Embodiment

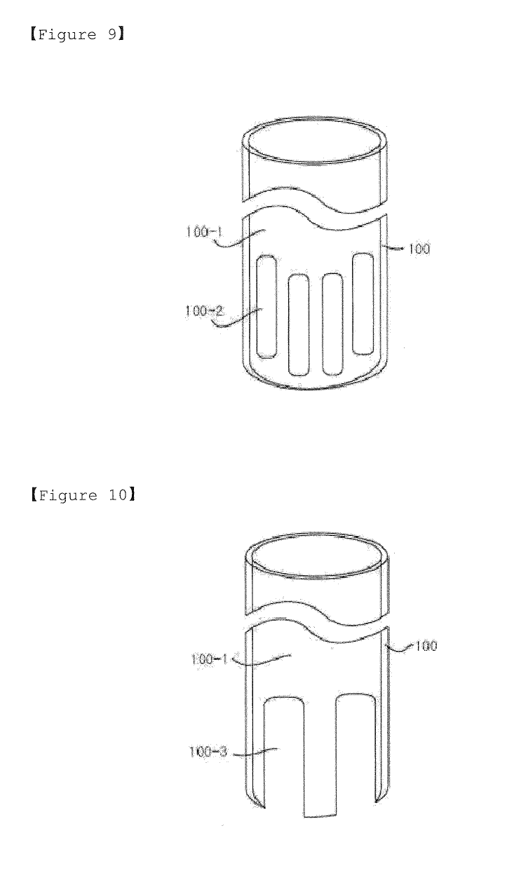

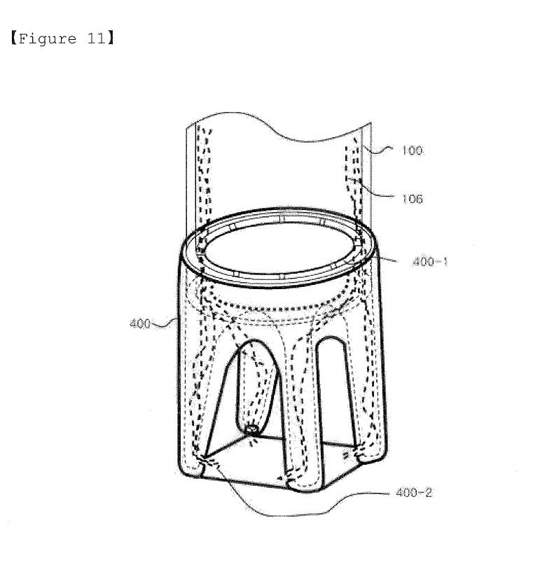

FIGS. 9 and 10 show a state in which flow channels 100-2 or 100-3 are formed at a lower portion or a lower end portion of the air purification chamber main body 100 to allow for flow of water and air between the interior and the exterior of the main body. In this case, the air purification chamber main body 100 is intended to be directly installed in the lower water tank 300 in a state in which the intermediate water tank 200 is excluded.

FIG. 11 shows a modified intermediate water tank 400 having a chair-type structure, which is configured to fixedly support the air purification chamber main body 100 and includes flow channels formed therein to prevent the noise of water falling from the top. The modified intermediate water tank 400 is a substitute for the intermediate water tank 200.

Besides the cases described above as examples, the connection of the water supply pipe using various methods and spray nozzle installation methods according to the connection of the water supply pipe may be combined, or the shape of the spray nozzles may be modified to improve the air purification capability. Alternatively, scattering protrusions 206-1 of various shapes may be formed on the top surfaces of the fan blades to increase a water scattering function, or the inner wall surface of the air purification chamber main body 100 may be formed with concavo-convex portions of various shapes such as a spiral shape, and the like to increase the contact surface area with polluted air to further improve the air purification capability.

Furthermore, when the air purification chamber main body 100 is made of a transparent material, an equivalent effect to that in which an outdoor fountain is installed indoor, is obtained. A new dimension fountain can be appreciated indoor, but not a general fountain having the shape of drops of water, which are spouted from an outdoor fountain and fall naturally. In other words, water drops sprayed from the inventive air purifier may take a shape in which the water drops flow down along a transparent inner wall surface of the air purification chamber while drawing a circular arc on the transparent inner wall surface to reduce a noise of water falling from the top. In addition, the interior design effect of an outlandish atmosphere can be expected in which water from the spray nozzles is shot to on the transparent wall surface of the air purification chamber as if a laser beam were projected on the wall surface.

While the present invention has been described with respect to the certain specific embodiments, it will be appreciated that the present invention is not limited to the above embodiments, but various equivalent modifications and variations to the disclosed embodiments can be made by a person of ordinary skill in the art to which the present invention pertains without departing from the spirit and scope of the present invention. Therefore, it is intended that the appended claims cover all such modifications and variations as fall within the true spirit and scope of the invention.

1. An wet-type air purifier that purifies air using the adsorption power of water, the air purifier comprising: a lower water tank 300 configured to store a certain amount of water therein, an intermediate water tank 200 disposed within the lower water tank, the intermediate water tank including an air outlet 212 formed at an upper portion thereof and an air circulation flow channel 214 formed at a lower portion thereof to fluidically communicate with the lower water tank; an air purification chamber main body 100 mounted at an upper portion of the intermediate water tank, the main body including a separation type cover at an upper end thereof and internally defining a space for purifying contaminated air, the cover having an air inlet formed thereon; a water jet type fan device 204 disposed at the inside of the air purification chamber and including a plurality of water spray nozzles mounted on a plurality of fan blades each having a flow channel formed thereon and a seal bearing mounted in a body of the fan device; a water supply pipe connected to the water jet type fan device and a water pump 215 connected to the water supply pipe to pump water up; a controller configured to control the water pump and a water flow control valve 210 of the water supply pipe; and a conical sloping plate 213 installed in the intermediate water tank so as to prevent the noise of water falling from the top,
wherein water contained in the lower water tank 300 is pumped by the water pump and the pumped water is sprayed and scattered by the water jet-type fan device 204 including a plurality of spray nozzles 201 and 205 mounted on the body and fan blades of the fan device having flow channels 207 formed thereon in order to purify contaminants, and wherein the fan device is rotated by the principle of action and reaction using the water spraying force as a rotation driving power, so that the air purifier performs a water spraying and scattering process and an air circulation function at the same time on a combination basis by adopting the water jet-type fan device 204 instead of a separate motor fan for circulating air, whereby eliminating the necessity of a complicated facility such as a separate motor fan for circulating air, a water spraying and scattering device, and the like, and improving efficiency and economic feasibility.

2. The air purifier according to claim 1, wherein the plurality of spray nozzles included in the water jet type fan device is independently mounted at an upper position 201 and a lower portion 205, respectively.

3. The air purifier according to claim 1 or 2, wherein the fan blades of the water jet type fan device are mounted so as to be separated from a body of the fan device so that when a defect due to a breakage occurs in the fan blade, only the defective fan blade can be easily replaced with new one.

4. The air purifier according to claim 1 or 2, wherein the fan device mounted with the seal bearing is mounted to the water supply pipe 209, and water is directly sprayed onto one or more hemispherical protrusions 206-2 formed on the top surfaces of the fan blades through the spray nozzles to rotate the fan blades.

5. The air purifier according to claim 1 or 2, wherein the fan blades of the water jet type fan device includes one or more conical scattering protrusions 206-1 formed on the top surfaces thereof.

6. The air purifier according to claim 1 or 2, wherein a plurality of water spray nozzles mounted at flow channels of the body of the water jet type fan device 204 connected to the water supply pipe 209 is controllable in spraying angle.

7. The air purifier according to claim 1 or 2, wherein the water jet type fan device is provided with a double-stage structure to further improve the air purification capability.

8. The air purifier according to claim 1 or 2, wherein the inner wall surface of the air purification chamber 100-1 is formed with concavo-convex portions of a spiral shape, and the like to increase the contact area with polluted air.

9. The air purifier according to claim 1 or 2, wherein the air purification chamber main body 100 is made of a transparent light material such as acryl, polycarbonate, or the like.

10. The air purifier according to claim 1 or 2, wherein the air purification chamber main body 100 is directly installed in the lower water tank in a state in which the intermediate water tank 200 is excluded, the air purification chamber main body including flow channels 100-2 or 100-3 formed at a lower portion or a lower end portion thereof to allow for flow of water and air between the interior and the exterior of the main body.

11. The air purifier according to claim 1 or 2, comprising a modified intermediate water tank 400 having a chair-type structure, which is configured to fixedly support the air purification chamber main body 100 and includes flow channels formed therein instead of the intermediate water tank 200.

12. An air purification method using an wet-type air purifier that purifies air using the adsorption power of water, the air purifier comprising: a lower water tank 300 configured to store a certain amount of water therein, an intermediate water tank 200 disposed within the lower water tank, the intermediate water tank including an air outlet 212 formed at an upper portion thereof and an air circulation flow channel 214 formed at a lower portion thereof to fluidically communicate with the lower water tank; an air purification chamber main body 100 mounted at an upper portion of the intermediate water tank, the main body including a separation type cover at an upper end thereof and internally defining a space for purifying contaminated air, the cover having an air inlet formed thereon; a water jet type fan device 204 disposed at the inside of the air purification chamber and including a plurality of water spray nozzles mounted on a plurality of fan blades each having a flow channel formed thereon and a seal bearing mounted in a body of the fan device; a water supply pipe connected to the water jet type fan device and a water pump 215 connected to the water supply pipe to pump water up; and a conical sloping plate 213 installed in the intermediate water tank so as to prevent the noise of water falling from the top, the air purification method being performed in which water contained in the lower water tank 300 is pumped by the water pump and the pumped water is sprayed and scattered by the water jet-type fan device 204 including a plurality of spray nozzles 201 and 205 mounted on the body and fan blades of the fan device having flow channels 207 formed thereon in order to purify contaminants, and in which the fan device is rotated by the principle of action and reaction using the water spraying force as a rotation driving power, so that the air purifier performs a water spraying and scattering process and an air circulation function by the rotation of the fan device due to the reaction to the action of the water spraying force at the same time on a combination basis by adopting the water jet-type fan device 204 instead of a separate motor fan for circulating air.

13. The air purification method according to claim 12, wherein when the air purification chamber main body 100 is made of a transparent material, an equivalent effect to that in which an outdoor fountain is installed indoor, is obtained, wherein a new dimension fountain can be appreciated indoor, but not a general fountain having the shape of drops of water, which are spouted from an outdoor fountain and fall naturally, wherein water drops sprayed from the inventive air purifier may take a shape in which the water drops flow down along a transparent inner wall surface of the air purification chamber while drawing a circular arc on the transparent inner wall surface to reduce a noise of water falling from the top, and wherein the interior design effect of an outlandish atmosphere can be expected in which water drops of various shapes from the spray nozzles are sprayed and scattered while impinging against the transparent inner wall surface of the air purification chamber in a swirling fashion to purify air, as if a laser beam were projected on the wall surface, and simultaneously.
